(19) United States
(12) Patent Application Publication
(10) Pub. No.: US 2003/0134544 A1
(43) Pub. Date: Jul. 17, 2003

(54) Electrical connection element

(76) Inventor: Robert Stenius, Tullinge (SE)

Correspondence Address: HARNESS, DICKEY & PIERCE, P.L.C., P.O. BOX 828, BLOOMFIELD HILLS, MI, 48303, US

(21) Appl. No.: 10/047,444

(22) Filed: Jan. 14, 2002

(51) Int. Cl. H01R 11/22

(52) U.S. Cl. 439/857

(57) ABSTRACT

A connection element for electrical connection between a power distribution bar and a circuit breaking unit. The units are adapted to be mounted on a rail, which is parallel with the power distribution bar, in a side by side relationship with other such units. The connection element has a first part to be electrically connected to the power distribution bar, and a second part to be electrically connected to the circuit breaking unit. The first part comprises two opposed and separated legs which are joined at an inner end portion of the first part and which are provided with mutually facing protrusions at an outer end portion of the first part. The distance between said protrusions is less than the thickness of the power distribution bar, whereby said protrusions are acting as electrical contact points when the legs are straddling the power distribution bar in a clamping engagement.

### TECHNICAL FIELD OF THE INVENTION

The present invention relates to a connection element for electrical connection between a power distribution bar and a circuit breaking unit adapted to be mounted on a rail, which is parallel with the power distribution bar, in a side by side relation-ship with other such units, said connection element having a first part to be electrically connected to the power distribution bar, and a second part to be electrically connected to the circuit breaking unit.

### BACKGROUND OF THE INVENTION

Within the electric power supply industry cabinets containing equipment, such as rectifiers, transformers etc. for electric distribution is frequently employed. These cabinets, or distribution units, comprise distribution bars arranged inside the cabinet for electrical power feeding to outlets, which outlets are protected against over-loading by circuit breaking units, such as circuit breakers, fuses and other protective devices.

A plurality of circuit breaking units are commonly mounted, side by side, on a rail inside the cabinet and then electrically connected to the distribution bar by means of connection elements. These connection elements may be formed as an integral part of the distribution bar in form of cut out fingers to be connected to e.g. a socket of the circuit breaking unit. An other related art solution comprises separate connection elements having a first part to be connected to the distribution bar by means of a screw joint, and a second part to be connected to e.g. the socket of the circuit breaking unit.

Depending on market demands and customer requirements the distribution units may contain combinations of circuit breaking units of different types, brands and ratings. Thus, the configuration and the design of the distribution bars has to be determined from case to case, since different combinations of circuit breaking units exhibit different physical dimensions, and thus, due to the aforementioned side-by-side arrangement, require different connection points on the distribution bars. This requires time consuming and expensive design work.

Moreover, if a circuit breaking unit has to be changed, e.g. due to faultiness, it has to be replaced with a device exhibiting the same physical dimensions. The reason is that it must fit in between adjacent circuit breaking units and must be connected to the same connection point of the distribution bar as for the replaced circuit breaking unit, which connection points are formed by the cut out fingers or screw joints arranged in bore holes of the distribution bars. In this context, specific problems may occur if the circuit breaking unit is accompanied with an auxiliary device to be positioned on a certain side of the circuit breaking unit. This creates an in-flexible system, which is restricted to specific brands of circuit breaking units, if not the whole distribution bar configuration is to be replaced.

Furthermore, the related art solutions neither permit the change of circuit breaking units without turning of the entire power system, since the circuit breaking units are connected to the electrically conducting distribution bars. This creates unnecessary and expensive operation stops.

### OBJECT OF THE INVENTION

An object of the present invention is to provide a connection element which can connect circuit breaking units of different ratings and dimensions to distribution bars.

Yet another object of the present invention is to provide a connection element which permit change of circuit breaking units without turning off the power system.

### SUMMARY OF THE INVENTION

These objects of the present invention are achieved by means of a connection element as initially defined and which is characterized in that said first part comprises two opposed and separated legs, which are joined at an inner end portion of said first part, and which are provided with mutually facing protrusions at an outer end portion of said first part, wherein the distance between said protrusions is less than the thickness of the power distribution bar, whereby said protrusions are acting as electrical contact points when said legs are straddling the power distribution bar in a clamping engagement.

Hereby is achieved that the connection element is movable along the power distribution bar, wherein the electrical connection points can be achieved anywhere along the distribution bar, which is advantageous when replacing defect units. The connection element is also movable across the power distribution bar, wherein the electrical connection points can be achieved anywhere across the distribution bar by means of the protrusions positioned at an outer end portion of the first part. Accordingly, a flexible and inexpensive system is created which will fit circuit breaking units of different physical dimensions using the same type of connection element. Furthermore, due to lack of screw joints it is possible to dismount the connection elements from the distribution bar without turning off the power system.

Suitably, each of said legs is provided with, at an outermost portion, a chamfered edge. Hereby, straddling of the power distribution bar is facilitated.

Preferably, each of said legs is provided with a narrowing portion. Hereby is achieved a resilient behavior of the legs when said legs are straddling the power distribution bar.

Advantageously, said first part is extending in a direction being perpendicular to a direction in which the second part is extending. Hereby is achieved that the second part can be connected to socket connectors disposed on a top or bottom side of the circuit breaking units, when the first part is connected to a horizontally arranged power distribution bar.

Suitably, a first side surface of the connection element is complementary to a second side surface of the connection element. Hereby, a plurality of connection elements may be stacked, whereby the same type of connection elements may be used when high currents are to be distributed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Preferred embodiments of the present invention will now be described with reference to the accompanying drawings, on which:

FIGS. 1a-c shows a front-and a back perspective view, as well as a top view of circuit breaking units connected to a distribution bar by means of connection elements in accordance with the present invention.

FIGS. 2a-d shows different embodiments of the connection element according to the present invention.

### DETAILED DESCRIPTION OF THE PREFERRED EMBODIMENTS

The following description of the preferred embodiment(s) is merely exemplary in nature and is in no way intended to limit the invention, its application, or uses.

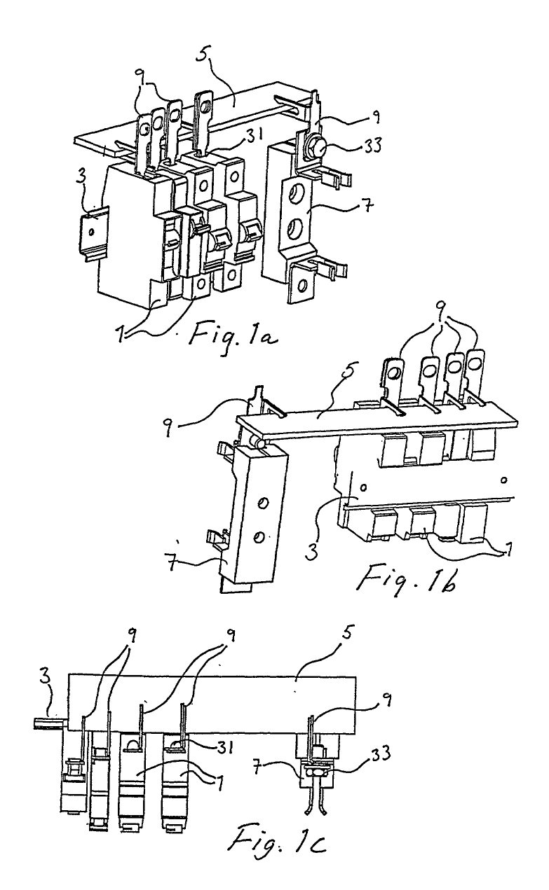

FIGS. 1a-c shows circuit breaking units 1 arranged inside a not shown cabinet, i.e. a distribution unit comprising electrical equipment for transformation and distribution of electric power to various power outlets. The circuit breaking units 1 are intended to protect the power outlets against electrical overload.

As can be seen from the figures four circuit breakers 1 are arranged side by side, and are mounted to an elongated, horizontal rail 3 through a back portion of each circuit breaker 1. As is obvious from FIG. 1c, the circuit breakers are of different physical dimensions, thus representing different brands or ratings. The different physical dimensions may imply different heights, widths and depths of the circuit breakers. Each circuit breaker is electrically connected to a distribution bar 5, which is parallel with, and arranged above the, mounting rail 3. A fuse holder 7 is also electrically connected to the distribution bar 5 (the fuse itself is omitted for the sake of clarity). The distribution bar 5 is rectangular in cross-section and commonly made from copper.

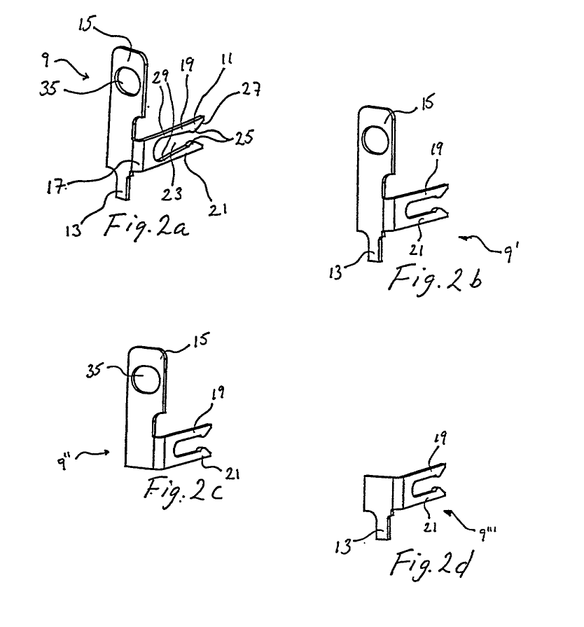

The electrical connection between the circuit breakers 1 and the fuse holder 7, respectively and the distribution bar 5 is obtained by means of a connection element 9, 9′, 9″, 9′″ in accordance with the present invention, which will be more thoroughly explained below with reference to FIGS. 2a-e.

FIG. 2a shows a preferred embodiment (best mode) of the connection element 9 depicted in FIGS. 1a-c. The connection element 9 is preferably made from cold-rolled copper, which gives it desired resilient properties, whereupon it is tin plated to improve electrical conductivity. The connection element comprises a flat blank of material in the form of a substantially T-shaped body, thus exhibiting first, second and third end parts 11, 13, 15, respectively. The first part 11 is disposed in a plane which is substantially perpendicular to a plane where the second 13 and third 15 parts are disposed. The reason is that the T-shaped body is provided with a right-angled bending in a transition area 17 between the first part 11 and the second 13 and third 15 parts. The first part 11 comprises two opposed and spaced apart legs 19, 21, which are joined at an inner end portion 17 of the first part, i.e. the above mentioned transition area. Thus, a gap 23 is formed between the legs 19, 21. The legs are intended to straddle and clamp the distribution bar 5 (shown in FIGS. 1a-c) for electrical contact with it. This is achieved by means of electrical contact points in the form of protrusions 25 arranged on the legs at an outer end portion of the first part 11. The protrusions 25 are facing each other, and the distance between the protrusions is less than the thickness of the power distribution bar 5 to be straddled. The outermost end portion of each leg is provided with chamfered edges 27. Moreover, each leg 19, 21 is provided with, at the inner end portion of the first part, a narrowing portion 29 gaining resilience to each leg in the direction towards each other. Accordingly, when the legs are straddling the distribution bar 5, the protrusions 25 will clamp the distribution bar and thus act as electrical contact points. The chamfered edges 27 as well as the narrowing portions 29 facilitate the straddling operation. The protrusions 25 will provide and secure for a reliable electrical contact with the distribution bar, due to the clamping engagement between protrusions 25 and distribution bar 5.

The second part 13 comprises a rectangular pin shaped end forming a plug portion 13 intended to fit into a socket connector 31 of a circuit breaking unit 1. Due to the right angle between the first 11 and the second parts 13 as well as the fact that the first part is intended to straddle a horizontally arranged distribution bar, the plug portion 13 need to connect a circuit breaking 1 unit having its socket connector 31 on a top or a bottom side. The third part 15 is a suspension attachment intended for a fuse holder 7. The fuse holder will be connected to the third part 15 by means of a screw joint 33, or similar joint, through a recess 35 arranged in the third part.

Referring to FIGS. 1a-c again, it is shown that each of the four circuit breakers 1 is connected to the second parts 13 of the connection elements 9, while the third parts 15 remain unemployed. The opposite apply for the fuse holder 7 to the right in FIG. 1a. Here, the third part 15 of the connection element is electrically connected to the fuse holder 7, while the second part 13 remain unemployed.

At a closer look at FIG. 1c it can be seen that the four circuit breakers are of different size, wherein the distance from the socket connector 31 of each circuit breaker to the distribution bar 5 is different after they have been mounted to the elongated rail 3 arranged below the distribution bar 5. However, since the first part 11 is provided with legs 19, 21 defining a gap 23, as well as that the fact that the aforementioned protrusions 25 are disposed at an outer end portion of the legs, the contact points between the power distribution bar and the connection element can be altered across the power distribution bar. Accordingly, the same connection element 9 can be used even though the physical dimensions of the circuit breaking units are different. This appears clearly in FIG. 1c, wherein the outermost ends of each connection element extends unequal distances across the distribution bar. Furthermore, due to the gap between the legs the connection elements are also movable along the distribution bar, which is advantageous when switching to a circuit breaking unit of different dimension.

The connection elements are stackable. This is achieved since a first side surface of the connection element 9 is complementary to a second side surface of the connection element, i.e. in this case, the contour of the first side surface is parallel with the contour of the second side surface. Since the connection elements are made from thin blanks of materials, a plurality of connection elements 9 may be stacked together and still electrically connect the distribution bar (through straddling) with the circuit breaking unit 1. This is shown for the fourth circuit breaking unit in FIGS. 1a-c, where two connection elements are stacked. The advantage with this stackability is that high currents can be distributed when more than one connection element is stacked. If a plurality of connection elements are stacked there is always a displacement of the stacked connection elements in some direction, wherein the connection points also are somewhat displaced. Thus, if the recess 35 mentioned earlier would have had a perimeter being completely round, it could be difficult to fit in a screw through the recesses of the stacked connection elements. For that reason the recesses 35 have a perimeter with an oval shape. So when a plurality of connection elements are stacked, the hole through the stacked connection elements would exhibit a substantially round shape.

FIG. 2b shows an alternative embodiment of the connection element 9′. Legs 19 in this embodiment have a substantially uniform thickness, which gives them a more rigid behavior compared to the embodiment shown in FIG. 2a, and thus an increased clamping force.

FIG. 2c shows yet an alternative embodiment of the connection element 9″, wherein the second part of the connection element has been removed, i.e. the part intended for the electrical connection between the distribution bar 5 and the socket connector 31 of a circuit breaking unit 1, which were shown in FIGS. 1a-c. This connection element 9″ will only provide for suspension of, e.g. a fuse holder by means of the third part 15 as described with reference to FIG. 2a.

FIG. 2d shows still yet an alternative embodiment of the connection element 9′″, wherein the third part of the connection element has been removed, i.e. the part intended for suspension of a fuse holder. Thus, this connection element 9′″ will only provide for connection between a distribution bar 5 and a socket connector 31 of a circuit breaking unit 1, as shown in FIGS. 1a-c.

Of course the second part does not need to have a rectangular shape as depicted in the figures. Any shape which is complimentary to the shape of a socket connector of the circuit breaking unit is conceivable.

The connection elements have in the figures exclusively been used in connection with horizontally arranged distribution bars. In spite of that, the connection elements can also be connected to inclined or vertically arranged distribution bars.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A connection element for electrical connection between a power distribution bar and a circuit breaking unit adapted to be mounted on a rail which is parallel with the power distribution bar, in a side by side relationship with other such units, said connection element having a first part to be electrically connected to the power distribution bar, and a second part to be electrically connected to the circuit breaking unit, wherein said first part comprises two opposed and separated legs which are joined at an inner end portion of said first part and which are provided with mutually facing protrusions at an outer end portion of said first part, the distance between said protrusions being less than the thickness of the power distribution bar, wherein said protrusions are acting as electrical contact points when said legs are straddling the power distribution bar in a clamping engagement.

2. The connection element according to claim 1 wherein each of said legs is provided with, at an outermost portion, a chamfered edge to facilitate straddling of the power distribution bar.

3. The connection element according to claim 1 wherein each of said legs is provided with a narrowing portion to facilitate a resilient behavior when said legs are straddling the power distribution bar.

4. The connection element according to claim 1 wherein said first part extends in a direction perpendicular to a direction in which the second part extends.

5. The connection element according to claim 1 wherein a first side surface of the connection element is complementary to a second side surface of the connection element, so as to facilitate stacking of a plurality of connection elements.

6. The connection element according to claim 1 wherein the second part has a pin shaped form for connection to a socket of the circuit breaking unit.

7. The connection element according to claim 6 further comprising a third part oppositely disposed in a same plane as the second part, wherein the third part comprises an ovally-shaped recess for optional suspension of a circuit breaking unit.

8. The connection element according to claim 1 wherein the second part comprises an ovally-shaped recess for suspension of a circuit breaking unit.

9. The connection element according to claim 8 further comprising a third part oppositely disposed in a same plane as the second part, wherein the third part has a pin shaped form for optional connection to a socket of the circuit breaking unit.

10. A connection element for electrical connection between a power distribution bar and a circuit breaking unit adapted to be mounted on a rail which is parallel with the power distribution bar, in a side by side relationship with other such units, said connection element including:
a first part to be electrically connected to the power distribution bar;
a second part to be electrically connected to the circuit breaking unit, said first part including two opposed and separated legs joined at an inner end portion of said first part and having mutually facing protrusions at an outer end portion of said first part, the distance between said protrusions being less than the thickness of the power distribution bar, wherein said protrusions are acting as electrical contact points when said legs are straddling the power distribution bar in a clamping engagement.

11. The connection element according to claim 10 wherein each of said legs includes a chamfered edge at an outermost portion to facilitate straddling of the power distribution bar.

12. The connection element according to claim 10 wherein each of said legs includes a narrowing portion to facilitate a resilient behavior when said legs are straddling the power distribution bar.

13. The connection element according to claim 10 wherein said first part extends in a direction perpendicular to a direction in which the second part extends.

14. The connection element according to claim 10 further comprising a first side surface of the connection element complementary to a second side surface of the connection element.

15. The connection element according to claim 10 wherein the second part further comprises a pin shaped form for connecting to a socket of the circuit breaking unit.

16. The connection element according to claim 16 further comprising a third part oppositely disposed in a same plane as the second part, wherein the third part comprises an ovally-shaped recess for optional suspension of a circuit breaking unit.

17. The connection element according to claim 10 where in the second part comprises an ovally-shaped recess for suspension of a circuit breaking unit.

18. The connection element according to claim 18 further comprising a third part oppositely disposed in a same plane as the second part, wherein the third part has a pin shaped form for optional connection to a socket of the circuit breaking unit.
